(19) United States
(12) Patent Application Publication
(10) Pub. No.: US 2025/0332864 A1
(43) Pub. Date: Oct. 30, 2025

(54) WHEEL ASSEMBLY AND VEHICLE INCLUDING THE SAME

(71) Applicants: HYUNDAI MOTOR COMPANY, Seoul (KR); KIA CORPORATION, Seoul (KR); HYUNDAI SUNGWOO CASTING CO., LTD., Seoul (KR)

(72) Inventors: Jae Hyuk Choi, Hwaseong-si (KR); Jeong Min Cho, Hwaseong-si (KR); Jun Hwan Park, Hwaseong-si (KR); Sang Bum Park, Chungju-si (KR); In Ho Seo, Chungju-si (KR)

(73) Assignees: HYUNDAI MOTOR COMPANY, Seoul (KR); KIA CORPORATION, Seoul (KR); HYUNDAI SUNGWOO CASTING CO., LTD., Seoul (KR)

(21) Appl. No.: 18/887,775

(22) Filed: Sep. 17, 2024

(30) Foreign Application Priority Data
Apr. 29, 2024 (KR) 10-2024-0056970

(51) Int. Cl. B60B 3/12

(52) U.S. Cl. CPC B60B 3/12; B60B 2360/10; B60B 2360/32; B60B 2900/111

(57) ABSTRACT

A wheel assembly includes a wheel, and an insert that is inserted into the wheel. In particular, the insert includes: an outer area defining a side of the insert in a radially outward direction, wherein the radially outward direction is defined as a direction in which a center of the wheel faces an outer peripheral surface of the wheel; and an inner area extending from the outer area in a radially inward direction opposite to the radially outward direction, and configured to define a side of the insert in the radially inward direction. The wheel includes: an insertion area configured such that the outer area is inserted thereinto; and a cover area extending from the insertion area in the radially inward direction and configured to surround a portion of the inner area.

### CROSS-REFERENCE TO RELATED APPLICATION

This application claims the benefit of and priority to Korean Patent Application No. 10-2024-0056970, filed in the Korean Intellectual Property Office on Apr. 29, 2024, the entire contents of which are incorporated herein by reference.

### TECHNICAL FIELD

The present disclosure relates to a wheel assembly and a vehicle including the same.

### BACKGROUND

The statements in this section merely provide background information related to the present disclosure and may not constitute prior art.

Generally, vehicle wheels are manufactured mainly of a single metal material to ensure sufficient durability. Meanwhile, wheels made of such metal have a relatively high weight, and due to the high weight, an acceleration performance and a suspension performance of the vehicle deteriorate.

In this regard, to achieve a lower weight than a wheel made only of metal while maintaining sufficient durability, recent research has focused on a wheel assembly that combines a lighter wheel with reinforcing inserts.

### SUMMARY

The present disclosure has been made to solve the above-mentioned problems occurring in the prior art while advantages achieved by the prior art are maintained intact.

An aspect of the present disclosure provides a wheel assembly that may ensure sufficient durability while having a relatively low weight.

The technical problems to be solved by the present disclosure are not limited to the aforementioned problems, and any other technical problems not mentioned herein will be clearly understood from the following description by those having ordinary skill in the art to which the present disclosure pertains.

According to an aspect of the present disclosure, a wheel assembly includes a wheel, and an insert that is inserted into the wheel. In one embodiment, the insert includes: an outer area defining a side of the insert in a radially outward direction, wherein the radially outward direction is defined as a direction in which a center of the wheel faces an outer peripheral surface of the wheel; and an inner area extending from the outer area in a radially inward direction opposite to the radially outward direction, and the inner area defines a side of the insert in the radially inward direction. In another embodiment, the wheel includes: an insertion area configured such that the outer area is inserted thereinto; and a cover area extending from the insertion area in the radially inward direction, and configured to surround a portion of the inner area. The inner area includes a first area surrounded by the insertion area and the cover area.

In one embodiment, the insert may have a ring shape, in which a hollow is formed, and the inner area may further include a second area, of which an end in the radially inward direction is exposed to the hollow of the insert.

In one embodiment, a plurality of first areas and a plurality of second areas may be provided in the wheel. In particular, the plurality of first areas and the plurality of second areas may alternately disposed along a circumferential direction of the wheel.

In one embodiment, an inner groove having a shape recessed in the radially outward direction with respect to the second area may be formed in the first area, and the cover area may be inserted into the inner groove.

In one embodiment, a width of the first area in a circumferential direction of the wheel may be smaller than a width of the second area in the circumferential direction of the wheel.

In one embodiment, the insert may further include a stepped area defining a step in a widthwise direction of the wheel between the inner area and the outer area.

In one embodiment, a thickness of the inner area in the widthwise direction of the wheel may be greater than a thickness of the outer area in the widthwise direction of the wheel.

In one embodiment, one side of the inner area in the widthwise direction may have a shape protruding in the widthwise direction with respect to the outer area.

In one embodiment, when an imaginary plane passing through a center of the insert and being perpendicular to the radially inward direction is defined as a first plane, and when a cutting surface obtained by cutting the insert by the first plane is viewed, an angle defined by a first straight line being an imaginary straight line passing through one end of the stepped area in the widthwise direction and an opposite end of the stepped area in the widthwise direction, and a second straight line being an imaginary straight line passing through one end of the outer area in the widthwise direction may be equal to or less than 90 degrees.

In one embodiment, when an imaginary plane passing through an opposite end of the insert in the widthwise direction and being perpendicular to the widthwise direction is defined as a reference plane, an opposite end of the inner area in the widthwise direction and an opposite end of the outer area in the widthwise direction may be located on the reference plane.

In one embodiment, an outer groove having a shape recessed in the radially inward direction, and an outer hole having a shape passing in the widthwise direction of the wheel may be formed in the outer area, a plurality of outer grooves and a plurality of outer holes may be provided in the wheel. In particular, the plurality of outer grooves and the plurality of outer holes may be alternately disposed along a circumferential direction of the wheel.

In one embodiment, the outer area and the inner area may be formed integrally.

In one embodiment, the wheel may include a plurality of column areas inserted into the plurality of outer holes, respectively.

In one embodiment, the insertion area, the cover area, and the plurality of column areas may be formed integrally.

In one embodiment, the insert may be disposed to be spaced apart from a center of the wheel to one side in the widthwise direction of the wheel.

In one embodiment, a stiffness of a material of the insert may be higher than a stiffness of a material of the wheel.

In one embodiment, the material of the insert may be a metal, and the material of the wheel may be plastic.

According to an aspect of the present disclosure, a vehicle includes a vehicle body, and a wheel assembly that is mounted on the vehicle body. The wheel assembly includes a wheel, and an insert that is inserted into the wheel. In particular, the insert includes: an outer area defining a side of the insert in a radially outward direction wherein the radially outward direction is defined as a direction in which a center of the wheel faces an outer peripheral surface of the wheel; and an inner area extending from the outer area in a radially inward direction opposite to the radially outward direction, and configured to define a side of the insert in the radially inward direction. The wheel includes an insertion area configured such that the outer area is inserted thereinto; and a cover area extending from the insertion area in the radially inward direction, and configured to surround a portion of the inner area. The inner area includes a first area surrounded by the insertion area and the cover area.

### BRIEF DESCRIPTION OF THE DRAWINGS

The above and other objects, features and advantages of the present disclosure should be more apparent from the following detailed description taken in conjunction with the accompanying drawings:

FIG. 1 is a perspective view of a wheel assembly according to an embodiment of the present disclosure;

FIG. 2 is a cross-sectional perspective view of a wheel assembly according to an embodiment of the present disclosure;

FIG. 3 is a cross-sectional perspective view of an insert according to an embodiment of the present disclosure;

FIG. 4 is a view illustrating one side of an insert according to an embodiment of the present disclosure;

FIG. 5 is a view illustrating an opposite side of an insert according to an embodiment of the present disclosure;

FIG. 6 is a first perspective view of a wheel according to an embodiment of the present disclosure;

FIG. 7 is a cross-sectional view illustrating that a column area of the wheel is inserted into an outer hole according to an embodiment of the present disclosure;

FIG. 8 is a second perspective view of a wheel according to an embodiment of the present disclosure; and

FIG. 9 is a cross-sectional perspective view of a wheel assembly according to another embodiment of the present disclosure.

### DETAILED DESCRIPTION

Hereinafter, embodiments of the present disclosure are described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof has been omitted.

When a component, device, element, or the like of the present disclosure is described as having a purpose or performing an operation, function, or the like, the component, device, or element should be considered herein as being “configured to” meet that purpose or to perform that operation or function.

Hereinafter, a wheel assembly 1 and a vehicle including the same according to the present disclosure is described with reference to the drawings.

Vehicles may be understood as a concept that includes a small mobility vehicle, a purpose-based vehicle (PBV), an electric vehicle, and an internal combustion engine vehicle. Such a vehicle may include a vehicle body, which defines an external appearance of the vehicle, and a wheel assembly 1.

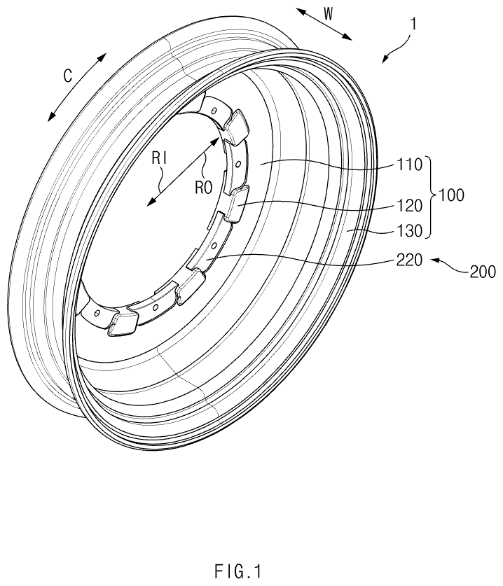

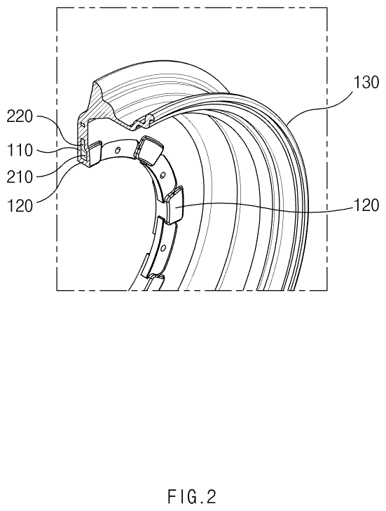

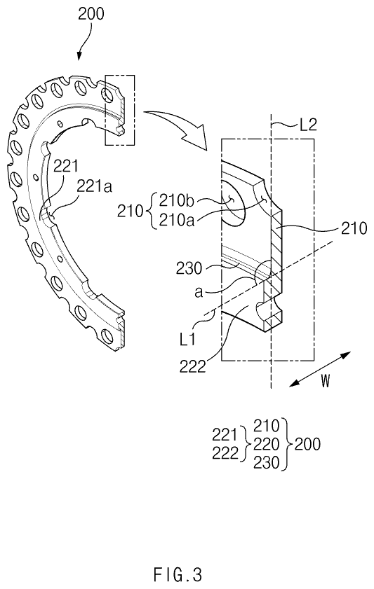

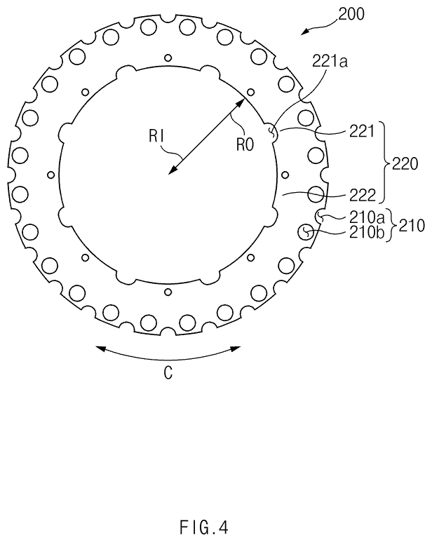

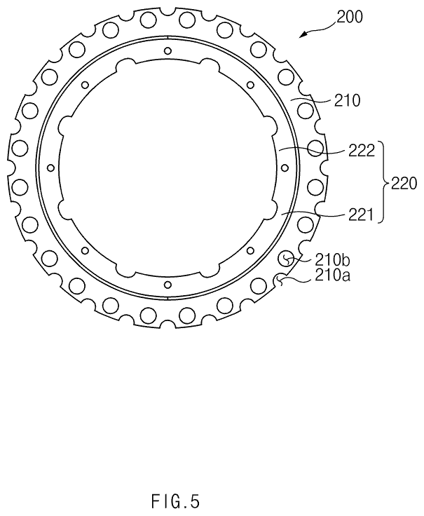

FIG. 1 is a perspective view of a wheel assembly according to an embodiment of the present disclosure, FIG. 2 is a cross-sectional perspective view of the wheel assembly according to an embodiment of the present disclosure, FIG. 3 is a cross-sectional perspective view of an insert according to an embodiment of the present disclosure, FIG. 4 is a view illustrating one side of the insert according to an embodiment of the present disclosure, and FIG. 5 is a view illustrating an opposite side of the insert according to an embodiment of the present disclosure.

Referring to FIGS. 1-5, a wheel assembly 1 may define at least a portion of a tire that is mounted on a vehicle. For example, the wheel assembly 1 may be provided in a small mobility vehicle, a purpose-based vehicle (PBV), and the like. The wheel assembly 1 may include a wheel 100 and an insert 200.

The wheel 100 may define an external appearance of the wheel assembly 1. As a detailed example, the wheel 100 may be manufactured through injection-molding by using an over-molding method through a mold (not illustrated) having a shape corresponding to shapes of the insert 200 and the wheel 100.

The wheel 100 may have a hollow ring shape. For example, the wheel 100 may have a hollow donut shape. Furthermore, a stiffness of the wheel 100 may be lower than the stiffness of the insert 200. As an example, the wheel 100 may be formed of plastic. The wheel 100 may include an insertion area 110, a cover area 120, a body area 130, and a column area 140.

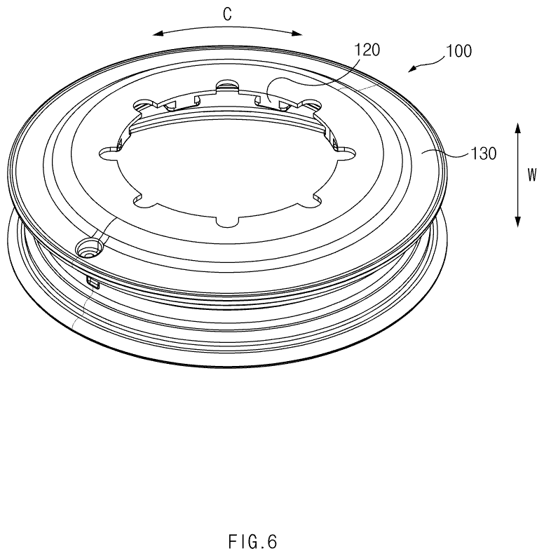

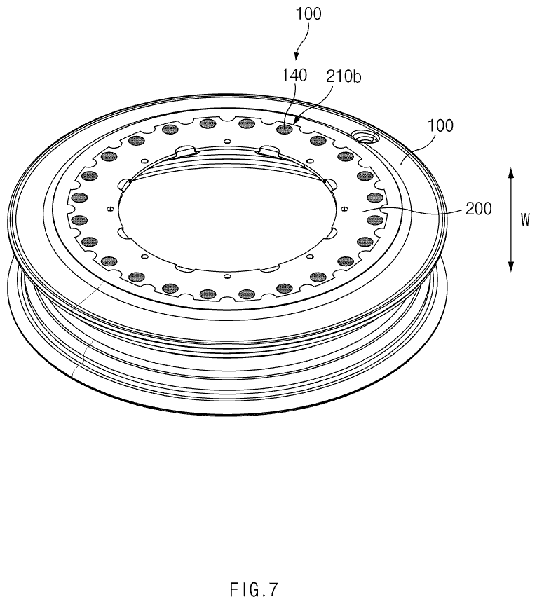

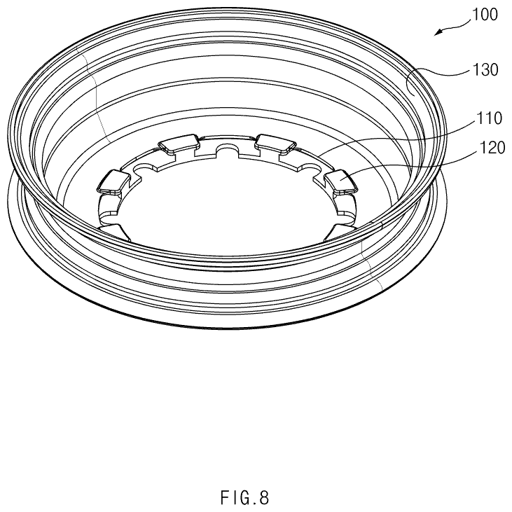

FIG. 6 is a first perspective view of the wheel according to an embodiment of the present disclosure, FIG. 7 is a cross-sectional view illustrating that a column area of the wheel is inserted into an outer hole according to an embodiment of the present disclosure, and FIG. 8 is a second perspective view of the wheel according to an embodiment of the present disclosure; and

Referring further to FIGS. 6 to 8, an outer area 210 of the insert 200, which is described below, may be inserted into the insertion area 110. The insertion area 110 may define a part of a side of the wheel 100 in a radially inward direction “RI”. An insertion groove that is a groove having a shape that is recessed toward a side of the wheel 100 in the radially inward direction RI may be formed in the insertion area 110. The insertion groove may extend in a circumferential direction “C” of the wheel 100.

The cover area 120 may be configured to surround a portion of an inner area 220 of the insert 200, which is described below. The cover area 120 may be configured to pass through a hollow of the insert 200. For example, when an imaginary plane that passes through the cover area 120 and is perpendicular to the circumferential direction “C” is defined as a cover reference plane, the inner area 220 may be located in the cover area 120 and the insertion area 110 when a cross-section obtained by cutting the wheel assembly 1 by the cover reference plane is viewed. The inner area 220 may be in close contact with the cover area 120 and the insertion area 110.

The cover area 120 may extend from the insertion area 110 in the radially inward direction RI. Furthermore, a plurality of cover areas 120 may be provided. The plurality of cover areas 120 may be disposed to be spaced apart from each other along the circumferential direction “C”. In one embodiment, the cover area 120 and the insertion area 110 may be formed integrally with each other.

The body area 130 may define an external appearance of the wheel 100. For example, an inner peripheral surface of the body area 130 may define an inner peripheral surface of the wheel 100, and an outer peripheral surface of the body area 130 may define an outer peripheral surface of the wheel 100. The inner peripheral surface of the body area 130 may define a specific empty space. An in-wheel motor and the like may be disposed in the empty space. Furthermore, the insertion area 110 and the cover area 120 may be disposed on one side of the body area 130 in a widthwise direction (“W”) of the wheel 100.

The column area 140 may be extended in the widthwise direction “W”. For example, the column area 140 may have a cylindrical shape. The column area 140 may be formed in an interior of body area 130. With respect to the radial direction RI and RO, the column area 140 may be disposed between an outer peripheral surface of the body area 130 and the insertion area 110.

The column area 140 may be inserted into an outer hole 210b, which is described below, to be in close contact with the insert 200. As an example, the column area 140 may have a shape corresponding to the outer hole 210b. A plurality of column areas 140 may be provided. The plurality of column areas 140 may be each other along the disposed to be spaced apart from circumferential direction “C”.

The insert 200 may be inserted into a side of the wheel 100 in the radially inward direction RI. The insert 200 may have a ring shape, in which a hollow is formed. For example, the insert 200 may have a donut shape, in which a hollow is formed. In one embodiment, the insert 200 may be formed of a metal material. The insert 200 may include an outer area 210 and an inner area 220.

Referring back to FIGS. 3-5, the outer area 210 may define a side of the insert 200 in the radially outward direction RO. The outer area 210 may be inserted into the insertion groove. An outer groove 210a and an outer hole 210b may be formed in the outer area 210.

The outer groove 210a may be formed at an end of the outer area 210 in the radially outward direction RO. The outer groove 210a may be a groove having a shape that is recessed in a radially inward direction RI. A plurality of outer grooves 210a may be provided. The plurality of outer grooves 210a may be disposed to be spaced apart from each other along the circumferential direction “C”.

The outer hole 210b may be a hole that is formed to pass through the outer area 210 in the widthwise direction “W”. A center of the outer hole 210b may be located on a side in the radially inward direction RI of a center of the outer groove 210a. In other words, the center of the outer hole 210b may be positioned radially inward from the center of the outer groove 210a in the radially inward direction RI. A plurality of outer holes 210b may be provided. The plurality of outer holes 210b may be disposed to be spaced apart from each other along the circumferential direction “C”. For example, the plurality of outer grooves 210a and the plurality of outer holes 210b may be alternately disposed along the circumferential direction “C”.

The inner area 220 may define a side of the insert 200 in the radially inward direction RI. The inner area 220 may extend from the outer area 210 in the radially inward direction RI. As one embodiment, the inner area 220 and the outer area 210 may be formed integrally with each other. Furthermore, in one form, the outer area 210, the inner area 220, and a stepped area 230 may be formed integrally with each other.

Furthermore, a thickness of the inner area 220 in the widthwise direction “W” may be greater than a thickness of the outer area 210 in the widthwise direction “W”. For example, one side of the inner area 220 in the widthwise direction “W” may have a shape that protrudes in the widthwise direction with respect to the outer area 210. The one side in the widthwise direction “W” may be defined as a side in a direction, in which the insert 200 faces the center of the wheel 100 with respect to the widthwise direction “W”. Furthermore, an opposite side in widthwise direction “W” may be defined as a side that is opposite to the one side in widthwise direction “W”. For example, one side of the inner area 220 in the widthwise direction “W” may have a shape that protrudes with respect to one side of the outer area 210 in the widthwise direction “W”.

In an embodiment, an opposite side of the inner area 220 in the widthwise direction “W” may have a shape that does not protrude from an opposite side of the outer area 210 in the widthwise direction. For example, the opposite end surface of the inner area 220 in the widthwise direction “W” and the opposite end surface of the outer area 210 in the widthwise direction “W” may be located on a reference plane. The reference plane may be defined as an imaginary plane that passes through an opposite end of the insert 200 in the widthwise direction “W” and is perpendicular to the widthwise direction “W”. In other words, an opposite end surface of the outer area 210 in the widthwise direction “W” and an opposite end surface of the inner area 220 in the widthwise direction “W” may be oriented in parallel to the radial direction RI and RO. The inner area 220 may include a first area 221 and a second area 222.

The first area 221 may be surrounded by the insertion area 110 and the cover area 120. For example, an end of the first area 221 in the radially inward direction RI may not be exposed to the hollow of the insert 200. As a detailed example, the cover area 120 may be configured to cover the outer surface of the first area 221 so that the first area 221 and the cover area 120 are in close contact with each other.

An inner groove 221a may be formed in the first area 221. The inner groove 221a may be formed at an end of the first area 221 in the radially inward direction RI. The inner groove 221a may have a shape that is recessed in the radially outward direction RO with respect to the second area 222. For example, the cover area 120 may be inserted into the inner groove 221a to pass through the inner groove 221a in the widthwise direction “W”. As a detailed example, when one side of the insert 200 in the circumferential direction “C” is viewed, the cover area 120 inserted into the inner groove 221a may overlap two adjacent second areas 222.

In one embodiment, a plurality of first areas 221 may be provided. The plurality of first areas 221 may be disposed to be spaced apart from each other along the circumferential direction “C”. For example, the first area 221 and the second area 222 may be formed integrally with each other.

An end of the second area 222 in the radially inward direction RI may be exposed to the hollow of the insert 200. In other words, the outer surface of the second area 222 may not contact the wheel 100. The second area 222 may be disposed between two adjacent first areas 221, among the plurality of first areas 221, in the circumferential direction “C”.

A counterpart product may be disposed on one surface of the second area 222 in the widthwise direction “W”. The counterpart product may refer to an arbitrary object (for example, an in-wheel motor) that may be coupled to or in close contact with the wheel assembly 1. One surface of the second area 222 in the widthwise direction “W” may have a flat planar shape that is perpendicular to the widthwise direction “W”.

A width of the second area 222 in the circumferential direction “C” may be different from a width of the first area 221 in the circumferential direction “C”. For example, a width of the first area 221 in the circumferential direction “C” may be smaller than a width of the second area 222 in the circumferential direction “C”. In the way, as a width of the second area 222 in the circumferential direction “C” is secured to be large, an area of one side surface of the second area 222 in the widthwise direction “W” may be increased. Accordingly, the counterpart product disposed in the second area 222 may be stably disposed on one side surface of the second area 222 in the widthwise direction “W”.

The stepped area 230 may define a step in the widthwise direction “W” between the outer area 210 and the inner area 220. The stepped area 230 may connect one end surface of the outer area 210 in the widthwise direction “W” and one end surface of the inner area 220 in the widthwise direction “W”.

Referring back to FIG. 3, a cutting surface obtained by cutting the insert 200 by a first plane (an imaginary plane that passes through the center of the insert 200 and is perpendicular to the radially inward direction RI) may be named a first cutting surface. When the first cutting surface is viewed, an imaginary straight line that passes through one end of the stepped area 230 in the widthwise direction “W” and an opposite end of the stepped area 230 in the widthwise direction “W” may be named a first straight line L1. When the first cutting surface is viewed, an imaginary straight line that passes through one end of the outer area 210 in the widthwise direction “W” may be named a second straight line L2.

For example, a first angle “a” that is an angle defined by the first straight line L1 and the second straight line L2 may be 90 degrees or less. For example, when the first angle “a” is greater than 90 degrees, one end of the stepped area 230 in the widthwise direction “W” may be in the radially outward direction of an opposite end of the stepped area 230 in the widthwise direction “W”. As another example, when the first angle “a” is 90 degrees, one end of the stepped area 230 in the widthwise direction “W” and an opposite end of the stepped area 230 in the widthwise direction “W” may be disposed to face each other in parallel to the widthwise direction “W”.

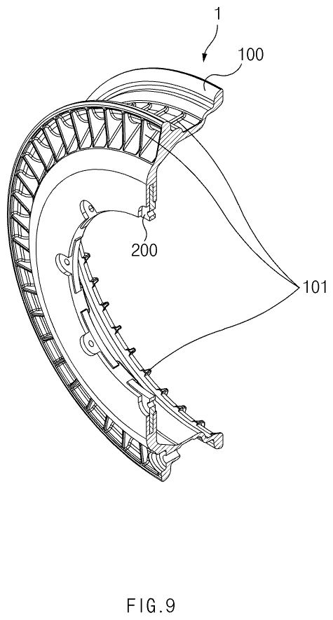

Referring to FIG. 9, a rib 101 may be formed in the wheel 100 according to another embodiment of the present disclosure. FIG. 9 is a cross-sectional perspective view of a wheel assembly according to another embodiment of the present disclosure.

As illustrated in FIG. 9, a plurality of ribs 101 may be provided in the wheel 100. The plurality of ribs 101 may include a plurality of first ribs, a plurality of second ribs, and a plurality of third ribs.

The plurality of first ribs may be disposed on an outer peripheral surface of the body area 130. The plurality of first ribs may be disposed to be spaced apart from each other along the circumferential direction “C”. The plurality of second ribs may be disposed on one side of the body area 130 in the widthwise direction “W”. The plurality of second ribs may be disposed to be spaced apart from each other along the circumferential direction “C”. The plurality of third ribs may be disposed on an opposite side of the body area 130 in the widthwise direction “W”. The plurality of third ribs may be disposed to be spaced apart from each other along the circumferential direction “C”.

The wheel assembly according to the present disclosure may improve an acceleration performance and a suspension performance of the vehicle while having a relatively low weight.

Furthermore, the wheel assembly according to the present disclosure may provide sufficient durability.

In the above description, just because all the components constituting the embodiment of the present disclosure are described as being combined or operating in combination, the present disclosure is not necessarily limited to this embodiment. In other words, within the scope of the purpose of the present disclosure, all of the components may operate in selective combination of one or more. In addition, terms such as “include,” “comprise,” or “have” described above mean that the corresponding component may be present, and thus do not exclude other components unless specifically stated to the contrary, and rather, it should be interpreted as being able to include other components. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A wheel assembly comprising:
a wheel; and
an insert configured to be inserted into the wheel,
wherein the insert includes:
an outer area defining a side of the insert in a radially outward direction, wherein the radially outward direction is defined as a direction in which a center of the wheel faces an outer peripheral surface of the wheel; and
an inner area extending from the outer area in a radially inward direction opposite to the radially outward direction, and configured to define a side of the insert in the radially inward direction,
wherein the wheel includes:
an insertion area configured such that the outer area is inserted thereinto; and
a cover area extending from the insertion area in the radially inward direction and configured to surround a portion of the inner area, and
wherein the inner area includes a first area surrounded by the insertion area and the cover area.

2. The wheel assembly of claim 1, wherein the insert has a ring shape, in which a hollow is formed, and
wherein the inner area further includes:
a second area, of which an end in the radially inward direction is exposed to the hollow of the insert.

3. The wheel assembly of claim 2, wherein a plurality of first areas and a plurality of second areas are alternately disposed along a circumferential direction of the wheel.

4. The wheel assembly of claim 2, wherein an inner groove having a shape recessed in the radially outward direction with respect to the second area is formed in the first area, and
wherein the cover area is inserted into the inner groove.

5. The wheel assembly of claim 2, wherein a width of the first area in a circumferential direction of the wheel is smaller than a width of the second area in the circumferential direction of the wheel.

6. The wheel assembly of claim 2, wherein the insert further includes:
a stepped area defining a step in a widthwise direction of the wheel between the inner area and the outer area.

7. The wheel assembly of claim 6, wherein a thickness of the inner area in the widthwise direction of the wheel is greater than a thickness of the outer area in the widthwise direction of the wheel.

8. The wheel assembly of claim 6, wherein one side of the inner area in the widthwise direction has a shape protruding in the widthwise direction with respect to the outer area.

9. The wheel assembly of claim 8, wherein when an imaginary plane passing through a center of the insert and being perpendicular to the radially inward direction is defined as a first plane, and
when a cutting surface obtained by cutting the insert by the first plane is viewed,
an angle defined by a first straight line being an imaginary straight line passing through one end of the stepped area in the widthwise direction and an opposite end of the stepped area in the widthwise direction, and a second straight line being an imaginary straight line passing through one end of the outer area in the widthwise direction is equal to or less than 90 degrees.

10. The wheel assembly of claim 8, wherein when an imaginary plane passing through an opposite end of the insert in the widthwise direction and being perpendicular to the widthwise direction is defined as a reference plane,
an opposite end of the inner area in the widthwise direction and an opposite end of the outer area in the widthwise direction are located on the reference plane.

11. The wheel assembly of claim 1, wherein an outer groove having a shape recessed in the radially inward direction, and an outer hole having a shape passing in a widthwise direction of the wheel are formed in the outer area,
wherein a plurality of outer grooves and a plurality of outer holes are alternately disposed along a circumferential direction of the wheel.

12. The wheel assembly of claim 1, wherein the outer area and the inner area are formed integrally.

13. The wheel assembly of claim 11, wherein the wheel includes:
a plurality of column areas inserted into the plurality of outer holes, respectively.

14. The wheel assembly of claim 13, wherein the insertion area, the cover area, and the plurality of column areas are formed integrally.

15. The wheel assembly of claim 1, wherein the insert is disposed to be spaced apart from a center of the wheel to one side in a widthwise direction of the wheel.

16. The wheel assembly of claim 1, wherein a stiffness of a material of the insert is higher than a stiffness of a material of the wheel.

17. The wheel assembly of claim 16, wherein the material of the insert is a metal, and
wherein the material of the wheel is plastic.

18. A vehicle comprising:
a vehicle body; and
a wheel assembly configured to be mounted on the vehicle body,
wherein the wheel assembly includes:
a wheel; and
an insert configured to be inserted into the wheel, wherein the insert includes:
an outer area defining a side of the insert in a radially outward direction, wherein the radially outward direction is defined as a direction in which a center of the wheel faces an outer peripheral surface of the wheel; and
an inner area extending from the outer area in a radially inward direction opposite to the radially outward direction, and configured to define a side of the insert in the radially inward direction,
wherein the wheel includes:
an insertion area configured such that the outer area is inserted thereinto; and
a cover area extending from the insertion area in the radially inward direction, and configured to surround a portion of the inner area, and
wherein the inner area includes a first area surrounded by the insertion area and the cover area.
